(19) United States
(12) Patent Application Publication
(10) Pub. No.: US 2025/0231457 A1
(43) Pub. Date: Jul. 17, 2025

(54) OPTICAL MODULATION ELEMENT

(71) Applicant: TDK CORPORATION, Tokyo (JP)

(72) Inventors: Hiroki HARA, Tokyo (JP); Takashi KIKUKAWA, Tokyo (JP)

(21) Appl. No.: 18/849,103

(22) PCT Filed: Mar. 23, 2022
(86) PCT No.: PCT/JP2022/013416

§ 371 Date: Sep. 20, 2024

(51) Int. Cl. G02F 1/225; G02F 1/21

(52) U.S. Cl. CPC G02F 1/225; G02F 1/212; G02F 2202/20

(57) ABSTRACT

An optical modulation element 1 includes a substrate; first and second waveguides formed of an optical material film having a ridge part which are disposed on the substrate and provided parallel to each other; a buffer layer disposed on the first and second waveguides; and first and second signal electrodes provided along the first and second waveguides. The first and second signal electrodes each include a solid-line part provided outside the respective first and second waveguides in a plan view and provided continuously in the traveling direction, a dashed-line part provided so as to overlap the respective first and second waveguides in a plan view and provided intermittently in the traveling direction, and a connection part connecting the solid-line part and dashed-line part. A width W₂ of the dashed-line part is larger than a width W₁ of the ridge part.

### TECHNICAL FIELD

The present disclosure relates to an optical modulation element.

### BACKGROUND ART

Communication traffic has been remarkably increased with widespread Internet use, and optical fiber communication has been increasingly significant. The optical fiber communication converts an electrical signal into an optical signal and transmits the resultant optical signal over an optical fiber, and has characteristics of a wide bandwidth, low loss, noise resistance, and the like.

As a system that converts an electric signal into an optical signal, a direct modulation system using a semiconductor laser and an external modulation system using an optical modulator are known. The direct modulation does not require an optical modulator and is low cost, but has a limitation in terms of high-speed modulation, and thus the external modulation system is used for high-speed and long-distance applications.

As an optical modulator, optical modulators of a type in which an optical waveguide is formed by Ti (titanium) diffusion in the vicinity of the surface of a lithium niobate single crystal substrate have been put to practical use. Among them, high-speed optical modulators of 40 Gb/s or more are commercialized, but the overall length thereof is as long as about 10 cm, which is a large disadvantage.

On the other hand, Patent Document 1 discloses a Mach-Zehnder type optical modulator in which a c-axis oriented lithium niobate film is formed by epitaxial growth on a sapphire single crystal substrate and used as an optical waveguide. Optical modulators using a lithium niobate film can be significantly reduced in size and drive voltage as compared with optical modulators using a lithium niobate single crystal substrate. However, to achieve a wider bandwidth, both a lower high-frequency loss and a lower drive voltage are required to be satisfied. Further, for achieving a wide bandwidth, there is a need for velocity matching between optical light and microwaves.

Regarding the velocity matching between light and microwaves, Patent Document 2, for example, discloses a slow wave electrode structure in which a thin fin is added to a pair of substantially parallel conductor strips so as to achieve capacitive coupling between the conductor strip pair. According to this electrode structure, it is possible to substantially increase capacitance per unit length between the strips to thereby reduce the phase speed of microwave signals. This allows achievement of velocity matching between light and microwaves.

Patent Document 3 describes an electro-optic device including a waveguide for transmitting an optical signal and an electrode for transmitting microwaves. The waveguide includes one or more optical material having an electro-optic effect, and the electrode includes a channel region and a plurality of extensions protruding from the channel region. The extensions of the electrode are closer to a portion of the waveguide than the channel region is, making it possible to reduce a difference in speed between optical and microwave signals. Further, Patent Document 3 discloses a so-called GSSG electrode structure in which a pair of ground electrodes (G) is disposed outside a pair of signal electrodes(S).

### CITATION LIST

### Patent Document

[Patent Document 1] Japanese Patent No. 6456662
[Patent Document 2] Japanese Patent Application Laid-open No. H06-510378
[Patent Document 3] U.S. Patent Application Publication No. 2021/0157177

### DISCLOSURE OF THE INVENTION

### Problem to be Solved by the Invention

However, in the conventional electrode structures described in Patent Documents 2 and 3, a protruding part is added to the signal electrode, so that the width of the entire electrode increases, which deteriorates electric field efficiency to the light waveguide to result in high drive voltage. Therefore, it is impossible to balance velocity matching between light and microwaves and low drive voltage.

The present disclosure has been made in view of the above situation, and an object thereof is to provide an optical modulation element capable of achieving both velocity matching between light and microwaves and a lower drive voltage.

### Means for Solving the Problems

To solve the above problems, an optical modulation element according to the present disclosure comprises a substrate; first and second waveguides formed of an optical material film having a ridge part which are disposed on the substrate and provided parallel to each other; a buffer layer disposed on the first and second waveguides; and first and second signal electrodes provided along the first and second waveguides, wherein the first and second signal electrodes each include a solid-line part provided outside the respective first and second waveguides in a plan view and continuously formed in the traveling direction, a dashed-line part provided at positions inside the solid-line parts so as to overlap the respective first and second waveguides in a plan view and provided intermittently in the traveling direction, and a connection part connecting the solid-line part and the dashed-line part, and a width of the dashed-line part is larger than a width of the ridge part.

### Advantageous Effects of the Invention

According to the present disclosure, there can be provided an optical modulation element capable of achieving both velocity matching between light and microwaves and a lower drive voltage.

### BRIEF DESCRIPTION OF THE DRAWINGS

FIGS. 1A and 1B are schematic plan views each illustrating the configuration of an optical modulation element according to a first embodiment of the present disclosure, in which FIG. 1A illustrates an optical waveguide pattern alone, and FIG. 1B illustrates an electrode pattern and the optical waveguide pattern in an overlapping manner.

FIGS. 2A and 2B are schematic cross-sectional views of the optical modulation element illustrated in FIGS. 1A and 1B, in which FIG. 2A is a cross-sectional view taken along the line X₁-X₁ in FIG. 1B, and FIG. 2B is a cross-sectional view taken along the line X₂-X₂ in FIG. 1B.

FIG. 3 is a schematic plan view illustrating in detail the shape of the first and second signal electrodes.

FIG. 4 is a schematic cross-sectional view illustrating the structure of an optical modulation element according to a second embodiment of the present disclosure.

FIG. 5 is a schematic plan view illustrating the structure of an optical modulation element according to a third embodiment of the present disclosure.

FIG. 6 is a schematic cross-sectional view illustrating the structure of an optical modulation element according to a fourth embodiment of the present disclosure.

FIG. 7 is a schematic plan view illustrating the structure of an optical modulation element according to a fifth embodiment of the present disclosure.

FIG. 8 is a graph showing a relationship between the connection part area length Ld and the effective refractive index Nm of microwaves.

FIG. 9 is a graph showing a relationship between the width SH of the connection part and the effective refractive index Nm of microwaves.

FIG. 10 is a graph showing a relationship between the thickness T of the electrode layer and the effective refractive index Nm of microwaves.

### MODE FOR CARRYING OUT OF THE INVENTION

Preferred embodiments of the present invention will now be explained in detail with reference to the accompanying drawings.

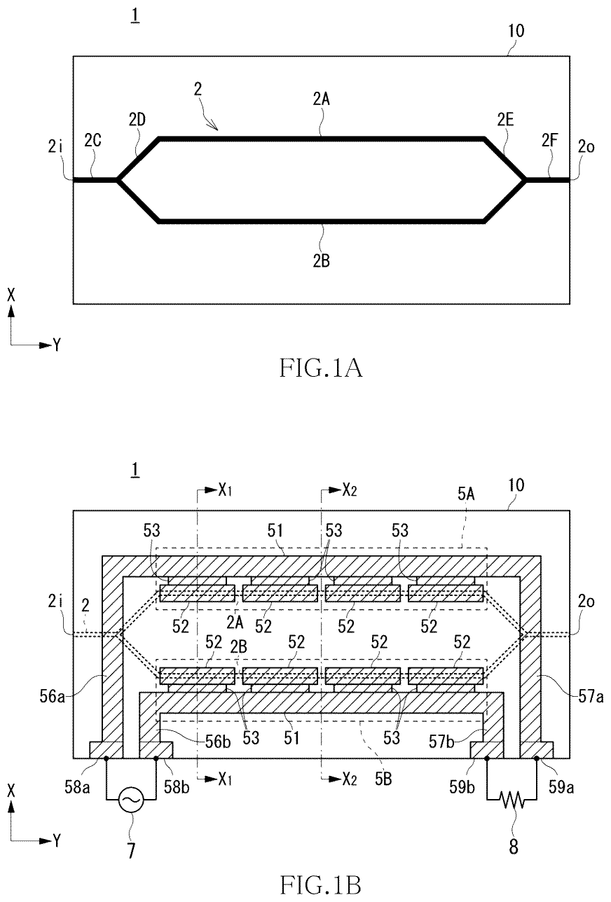

FIGS. 1A and 1B are schematic plan views each illustrating the configuration of an optical modulation element according to a first embodiment of the present disclosure, in which FIG. 1A illustrates an optical waveguide pattern alone, and FIG. 1B illustrates an electrode pattern and the optical waveguide pattern in an overlapping manner.

As illustrated in FIGS. 1A and 1B, an optical modulation element 1 includes a Mach-Zehnder optical waveguide 2 formed on a substrate 10 and having first and second waveguides 2A, 2B provided in parallel to each other, a first signal electrode 5A provided along the first waveguide 2A, and a second signal electrode 5B provided along the second waveguide 2B.

The Mach-Zehnder optical waveguide 2 is an optical waveguide having a Mach-Zehnder interferometer structure. The Mach-Zehnder optical waveguide 2 has an input waveguide 2C, a demultiplexer 2D branching light propagating through the input waveguide 2C, first and second waveguides 2A, 2B extending in parallel from the demultiplexer 2D, a multiplexer 2E multiplexing lights propagating through the first and second waveguides 2A, 2B, and an output waveguide 2F through which light output from the multiplexer 2E propagates.

As illustrated, the Mach-Zehnder optical waveguide 2 extends in the longitudinal direction (Y-direction) of the substrate 10. An optical input port 2i, which is one end of the input waveguide 2C, is provided at one end side of the substrate 10 in the longitudinal direction. An optical output port 2o, which is one end of the output waveguide 2F, is provided at the other end side of the substrate 10 in the longitudinal direction. Light input to the optical input port 2i travels through the input waveguide 2C and is branched at the demultiplexer 2D. The branched lights travel through the first and second waveguides 2A, 2B, respectively, and are multiplexed at the multiplexer 2E. The multiplexed light is then output from the optical output port 2o of the output waveguide 2F as a modulated light.

The first and second signal electrodes 5A, 5B are provided for applying a microwave signal to the first and second waveguides 2A, 2B, respectively, and constitute an interaction part of the optical modulation element 1 together with the Mach-Zehnder optical waveguide 2. The first and second signal electrodes 5A, 5B are substantially linear electrode patterns overlapping the first and second waveguides 2A, 2B, respectively, in a plan view, and both ends thereof are drawn to the vicinity of the outer peripheral end of the substrate 10. More specifically, one end and the other end of the first signal electrode 5A are drawn to the vicinity of one outer peripheral end of the substrate 10 in the width direction (X-direction) by draw-out parts 56a, 57a, and one end and the other end of the second signal electrode 5B are drawn to the vicinity of the one outer peripheral end of the substrate 10 in the width direction by draw-out parts 56b, 57b.

The one ends of the respective first and second signal electrodes 5A, 5B are respectively connected, through the draw-out parts 56a, 56b, to a pair of terminal parts 58a, 58b provided in the vicinity of the one outer peripheral end of the substrate 10 in the width direction. The pair of terminal parts 58a, 58b constitute a signal input port to which a driver circuit 7 is connected. The other ends of the respective first and second signal electrodes 5A, 5B are respectively connected, through the draw-out parts 57a, 57b, to a pair of terminal parts 59a, 59b provided in the vicinity of the one outer peripheral end of the substrate 10 in the width direction. The pair of terminal parts 59a, 59b are connected to each other through a terminal resistor 8.

The first and second signal electrodes 5A, 5B each include a solid-line part 51 continuously formed without any breaks in the traveling direction, a dashed-line part 52 provided parallel to the solid-line part 51 and intermittently formed in the traveling direction, and a connection part 53 connecting the solid-line part 51 and the dashed-line part 52.

The pair of solid-line parts 51, 51 are respectively provided at positions outside the mutually parallel first and second waveguides 2A, 2B so as not to overlap the first and second waveguides 2A, 2B in a plan view. Specifically, the solid-line part 51 of the first signal electrode 5A is disposed in the vicinity of the first waveguide 2A but does not overlap the first waveguide 2A in a plan view. Similarly, the solid-line part 51 of the second signal electrode 5B is disposed in the vicinity of the second waveguide 2B but does not overlap the second waveguide 2B in a plan view.

The pair of dashed-line parts 52, 52 are respectively provided at positions inside the pair of solid-line parts 51, 51 so as to overlap the first and second waveguides 2A, 2B in a plan view. Specifically, the dashed-line part 52 of the first signal electrode 5A is disposed just above the first waveguide 2A. Similarly, the dashed-line part 52 of the second signal electrode 5B is disposed just above the second waveguide 2B.

In the present embodiment, the dashed-line part 52 and connection part 53 constitute a protruding part protruding in the width direction from one sides of the respective first and second signal electrodes 5A, 5B to the other sides thereof. By thus periodically providing the protruding part along the extending direction of the signal electrode to locally reduce the inter-line distance between the first and second signal electrodes 5A, 5B, it is possible to increase the capacitance per unit length of the strip conductor to thereby increase the effective refractive index Nm of microwaves. This reduces the speed of microwaves to allow achievement of velocity matching between light and microwaves.

Differential signals (modulated signals) having the same absolute value but opposite polarities are input to the one ends of the respective first and second signal electrodes 5A, 5B. The first and second waveguides 2A, 2B are each formed of an optical material having an electro-optic effect, such as lithium niobate, so that the refractive indices of the first and second waveguides 2A, 2B change by +Δn and −Δn by application of an electric field to the first and second waveguides 2A, 2B to change the phase difference between the pair of optical waveguides. A signal light modulated by the change in the phase difference is output from the output waveguide 2F.

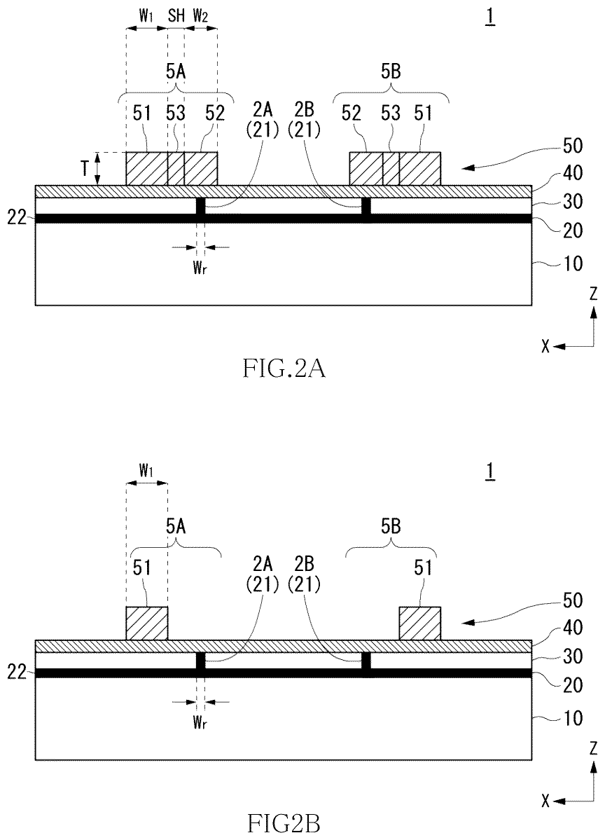

FIGS. 2A and 2B are schematic cross-sectional views of the optical modulation element illustrated in FIGS. 1A and 1B, in which FIG. 2A is a cross-sectional view taken along the line X₁-X₁ in FIG. 1B, and FIG. 2B is a cross-sectional view taken along the line X₂-X₂ in FIG. 1B.

As illustrated in FIGS. 2A and 2B, the optical modulation element 1 has a multilayer structure including the substrate 10, a waveguide layer 20, a protective layer 30, a buffer layer 40, and an electrode layer 50 which are stacked in this order.

The waveguide layer 20 made of an electro-optic material represented by lithium niobate is formed on the main surface of the substrate 10. The waveguide layer 20 has ridge parts 21, i.e., projecting parts, and a slab part 22 provided on both sides of each of the ridge parts 21 and having a reduced thickness. The ridge parts 21 constitute the Mach-Zehnder optical waveguide 2 including the first and second waveguides 2A, 2B. In the present embodiment, a width (ridge width) Wr of the ridge part 21 can be set to 0.5 μm to 5 μm.

The ridge part 21 is the main part of the optical waveguide and refers to an upwardly projecting part. The projecting part has a larger thickness of the electro-optic material film than that of left and right portions thereof and thus has a high effective refractive index. This allows light to be confined also in the left-right direction, thus achieving a function as a three-dimensional optical waveguide. The ridge part 21 may have any shape as long as it can guide light and has a larger thickness of the electro-optic material film than that of left and right portions thereof. In forming the ridge part 21, a mask such as a resist is formed on an electro-optic material, and the electro-optic material is selectively etched for patterning.

The protective layer 30 covers the entire upper surface of the waveguide layer 20 excluding the formation area of the ridge parts 21. The side surfaces of each of the ridge parts 21 are also covered with the protective layer 30, so that scattering loss caused due to the roughness of the side surfaces of the ridge part 21 can be prevented. The thickness of the protective layer 30 is substantially equal to the height of the ridge part 21 of the waveguide layer 20. There is no particular restriction on the material of the protective layer 30 and, for example, silicon oxide (SiO₂) may be used.

The buffer layer 40 is formed on at least the upper surfaces of the ridge parts 21 so as to prevent light propagating through the first and second waveguides 2A, 2B from being absorbed by the first and second signal electrodes. The protective layer 30 may be omitted, and in this case, the buffer layer 40 may be used to cover the upper and side surfaces of the ridge part 21. The buffer layer 40 is preferably formed of a dielectric material (dielectric layer) having a lower refractive index than the waveguide layer 20 and a higher transparency. For example, Al₂O₃, SiO₂, LaAlO₃, LaYO₃, ZnO, HfO₂, MgO, or Y₂O₃ may be used. The thickness of the buffer layer 40 on the upper surface of the ridge part 21 may be about 0.2 μm to 2 μm.

The buffer layer 40 with a larger thickness can prevent light absorption by the electrode more effectively, and the buffer layer 40 with a smaller thickness can apply a higher electric field to the optical waveguide. The light absorption and applied voltage of an electrode have a trade-off relation, so that it is necessary to set adequate film thickness according to the purpose. The buffer layer 40 with a higher dielectric constant can reduce VπL, and the buffer layer 40 having a lower refractive index can have a smaller thickness. The VπL is a product of a drive voltage required for shifting the phase of light by a half wavelength (π), i.e., half wavelength voltage Vπ and a length L of the interaction part of the optical modulation element and is an index representing the performance of the optical modulation element. The smaller the value of the VπL, the higher the modulation efficiency, and the higher the performance becomes.

In general, a material having a high dielectric constant has a higher refractive index, so that it is important to select a material having a high dielectric constant and a relatively lower refractive index considering the balance therebetween. For example, Al₂O₃ has a specific dielectric constant of about 9 and a refractive index of about 1.6 and is thus preferable. LaAlO₃ has a specific dielectric constant of about 13 and a refractive index of about 1.7, and LaYO₃ has a specific dielectric constant of about 17 and a refractive index of about 1.7 and are thus particularly preferable.

The electrode layer 50 includes the first and second signal electrodes 5A, 5B constituting the interaction part together with the first and second waveguides 2A, 2B. As described above, the first and second signal electrodes 5A, 5B each have the solid-line part 51 provided along the first waveguide 2A or second waveguide 2B, the dashed-line part 52 provided parallel to the solid-line part 51, and the connection part 53 connecting the solid-line part 51 and dashed-line part 52. A width W₁ of the solid-line part 51 is preferably larger than a width W₂ of the dashed-line part 52. This allows propagation of microwaves to concentrate on the solid-line part 51 to thereby suppress an excessive increase in the effective refractive index Nm of microwaves.

In the present embodiment, the ridge part 21 constituting the optical waveguide is just below the dashed-line part 52. By disposing the optical waveguide not just below the pair of solid-line parts 51 (distance between electrodes is large), but just below the dashed-line parts 52 (distance between electrodes is small), it is possible to reduce the distance between the pair of ridge parts constituting the interaction part, whereby the VπL can be reduced.

The width W₂ of the dashed-line part 52 is preferably slightly larger than the ridge width Wr of each of the first and second waveguides 2A, 2B each formed of lithium niobate film with a ridge shape. That is, in a plan view, the ridge part 21 is disposed between the inner and outer edges of the dashed-line part 52 in a direction perpendicular to the traveling direction. To allow an electric field from the first and second signal electrodes 5A, 5B to concentrate on the ridge parts 21, the width W₂ of the dashed-line part 52 of each of the first and second signal electrodes 5A, 5B is preferably 1.05 times to 15 times, more preferably, 1.2 times to 10 times the ridge width Wr of each of the first and second waveguides 2A, 2B.

A width SH of the connection part 53 in the X-direction is preferably 1 μm to 50 μm, although depending on a required Nm. The length of the protruding part increases as the width SH of the connection part 53 increases, increasing capacitance per unit length of a differential line, which in turn increases the Nm. Thus, it is necessary to adequately set the width SH of the connection part 53 so as to achieve velocity matching between light and microwaves. The ridge width Wr, width W₁ of the solid-line part 51, width W₂ of the dashed-line part 52, and width SH of the connection part 53 are each a length dimension in the X-direction perpendicular to both the traveling and stacking directions.

In the present embodiment, the upper surfaces of the respective solid-line part 51, dashed-line part 52, and connection part 53 are the same in height. To increase the Nm, a thickness T of the electrode layer 50 should desirably be as large as possible; however, it is difficult to make the thickness of the electrode layer 50 very large due to restrictions on the manufacturing process. Thus, it is desirable to increase the Nm by optimizing the shape of the dashed-line part 52 and connection part 53 without excessively increasing the thickness T of the electrode layer 50.

The waveguide layer 20 is not particularly limited as long as it is made of an electro-optic material and is preferably made of lithium niobate. This is because lithium niobate has a large electro-optic constant and is thus suitable as the constituent material of an optical device such s an optical modulation element. Hereinafter, the configuration of the present embodiment when the waveguide layer 20 is formed using a lithium niobate film will be described in detail.

Although the substrate 10 is not particularly limited as long as it has a lower refractive index than that of a lithium niobate film, the substrate 10 is preferably a substrate on which the lithium niobate film can be formed as an epitaxial film. Specifically, the substrate 10 is preferably a sapphire single crystal substrate, a silicon single crystal substrate, or a quartz substrate. The crystal orientation of the single crystal substrate is not particularly limited. The lithium niobate film can be easily formed as a c-axis oriented epitaxial film on single crystal substrates having different crystal orientations. Since the c-axis oriented lithium niobate film has three-fold symmetry, the underlying single crystal substrate preferably has the same symmetry. Thus, when the sapphire single crystal substrate is used as the substrate 10, it preferably has a c-plane, and when the silicon single crystal substrate is used as the substrate 10, it preferably has a (111) surface.

The epitaxial film refers to a film having the crystal orientation of the underlying substrate or film. When the film in-plane surface is defined as an X-Y plane, and the film thickness direction is as a Z-axis, the crystal is uniformly oriented along the X-, Y-, and Z-axes. For example, an epitaxial film can be confirmed by first measuring the peak intensity at the orientation position by 2θ-θ X-ray diffraction and secondly observing poles.

Specifically, first, in the 2θ-θ X-ray diffraction measurement, all the peak intensities except for the peak intensity on a target surface must be equal to or less than 10%, preferably equal to or less than 5%, of the maximum peak intensity on the target surface. For example, in a c-axis oriented epitaxial lithium niobate film, the peak intensities except for the peak intensity on a (00L) surface are equal to or less than 10%, preferably equal to or less than 5%, of the maximum peak intensity on the (00L) surface. The (00L) is a general term for (001), (002), and other equivalent surfaces.

Secondly, poles must be observed in the measurement. Under the condition where the peak intensities are measured at the first orientation position, only the orientation in a single direction is proved. Even if the first condition is satisfied, in the case of nonuniformity in the in-plane crystalline orientation, the X-ray intensity is not increased at a particular angle, and poles cannot be observed. Since LiNbO₃ has a trigonal crystal system, single crystal LiNbO₃ (014) has three poles.

For the lithium niobate film, it is known that crystals rotated by 180° about the c-axis are epitaxially grown in a symmetrically-coupled twin crystal state. In this case, three poles are symmetrically-coupled to form six poles. When the lithium niobate film is formed on a silicon single crystal substrate having a (100) surface, the substrate has four-fold symmetry, and 4×3=12 poles are observed. In the present disclosure, the lithium niobate film epitaxially grown in the twin crystal state is also considered to be an epitaxial film.

The lithium niobate film has a composition of LixNbAyOz. A denotes an element other than Li, Nb, and O, wherein x ranges from 0.5 to 1.2, preferably 0.9 to 1.05, y ranges from 0 to 0.5, and z ranges from 1.5 to 4, preferably 2.5 to 3.5. Examples of the element A include K, Na, Rb, Cs, Be, Mg, Ca, Sr, Ba, Ti, Zr, Hf, V, Cr, Mo, W, Fe, Co, Ni, Zn, Sc, and Ce, alone or a combination of two or more of them.

The lithium niobate film preferably has a film thickness of 2 μm or less. This is because a high-quality lithium niobate film having a thickness more than 2 μm is difficult to form. The lithium niobate film having an excessively small thickness cannot completely confine light in it, disadvantageously allowing the light to penetrate through the substrate 10 and/or the buffer layer 40. Application of an electric field to the lithium niobate film may therefore cause a change in the effective refractive index of the optical waveguide to decrease. Thus, the lithium niobate film preferably has a film thickness that is at least approximately one-tenth or more of the wavelength of light to be used.

The lithium niobate film is preferably formed using a film formation method, such as sputtering, CVD or sol-gel process. Application of an electric field in parallel to the c-axis of the lithium niobate that is oriented perpendicular to the main surface of the substrate 10 can change the optical refractive index in proportion to the electric field. In the case of the single crystal substrate made of sapphire, the lithium niobate film can be directly epitaxially grown on the sapphire single crystal substrate. In the case of the single crystal substrate made of silicon, the lithium niobate film is epitaxially grown on a clad layer (not illustrated). The clad layer has a refractive index lower than that of the lithium niobate film and should be suitable for epitaxial growth. For example, a high-quality lithium niobate film can be formed on a clad layer made of Y₂O₃.

As a formation method for the lithium niobate film, there is known a method of thinly polishing or slicing the lithium niobate single crystal substrate. This method has an advantage that characteristics same as those of the single crystal can be obtained and can be applied to the present disclosure.

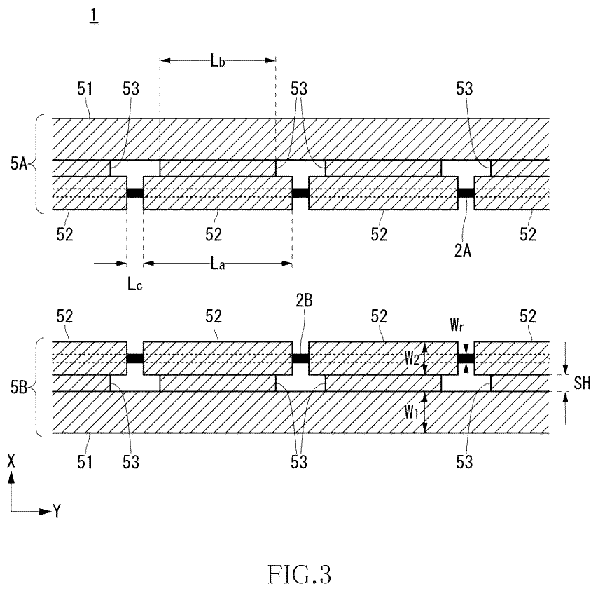

FIG. 3 is a schematic plan view illustrating in detail the shape of the first and second signal electrodes 5A, 5B.

As illustrated in FIG. 3, the first and second signal electrodes 5A, 5B each include the solid-line part 51 continuously formed in the traveling direction (Y-direction), the dashed-line part 52 provided parallel to the solid-line part 51 and intermittently formed in the traveling direction, and the connection part 53 connecting the solid-line part 51 and dashed-line part 52.

In the present embodiment, the line width W₁ of the solid-line part 51 is preferably larger than the line width W₂ of the dashed-line part 52. This allows propagation of microwaves to concentrate on the solid-line part 51 to thereby suppress an excessive increase in the effective refractive index Nm of microwaves.

The dashed-line part 52 includes a plurality of line segment patterns arranged at a constant interval with an insulating space of a predetermined length interposed therebetween. The line width W₂ of the dashed-line part 52 is larger than the width Wr of the ridge part and is, for example, 1.5 μm to 10 μm. A length La of the segment pattern (division part) of the dashed-line part 52 is preferably 10 μm to 500 μm. An interval Lc of the dashed-line parts 52, i.e., the distance between adjacent line segment patterns is preferably as small as possible and is preferably 1 μm to 50 μm. This is because the larger the interval Lc of the dashed-line part 52, the wider the area of the section that cannot apply an electric field to the ridge part 21 to result in an increase in half wavelength voltage VT.

The connection part 53 is a conductor pattern that electrically connects the solid-line part 51 and the dashed-line part 52. One end of the connection part 53 in the width direction (X-direction) is connected to the solid-line part 51, and the other end thereof in the width direction (X-direction) is connected to the dashed-line part 52. A length Lb of the connection part 53 is preferably smaller than the length La of the segment pattern of the dashed-line part 52. This can increase the effective refractive index Nm of microwaves. In the present embodiment, the length Lb of the connection part 53 is preferably larger than the half of the length La of the dashed-line part 52 (Lb/La>0.5). That is, in the present embodiment, the length Lb of the connection part 53 is equal to the maximum distance of the formation area of the connection part 53 connected to one dashed-line part 52. When the length Lb (i.e., the maximum distance of the formation area of the connection part 53) of the connection part 53 is excessively small, the Nm excessively increases to make it difficult to achieve velocity matching between light and microwaves. By making the length Lb of the connection part 53 larger than half of the length La of the dashed-line part 52, even when a high dielectric constant substrate is used for the substrate, it is possible to suppress an excessive increase in the Nm without making the thickness of the electrode layer excessively large to allow achievement of velocity matching between light and microwaves. Although the connection pattern 53 is a conductor pattern intermittently formed in the traveling direction like the dashed-line part 52, the segment pattern thereof is smaller in length than that of the dashed-line part 52.

In the present embodiment, the dashed-line part 52 and connection part 53 constitute the protruding part protruding in the width direction from the solid-line part 51 of one signal electrode to the other signal electrode. By thus periodically providing the protruding part to locally reduce the inter-line distance between the first signal electrode 5A and the second signal electrodes 5B, it is possible to increase the capacitance per unit length of the strip conductor to thereby increase the refractive index of microwaves. This allows achievement of velocity matching between light and microwaves.

As described above, in the optical modulation element 1 according to the present embodiment, the parallel-arranged first and second signal electrodes 5A, 5B constituting a differential line each include the solid-line part 51 and the dashed-line part 52 connected to the solid-line part 51 through the connection part 53, and the dashed-line part 52 and connection part 53 are provided between the pair of solid-line parts 51, 51, so that it is possible to increase the effective refractive index Nm of microwaves. This reduces the speed of microwaves to thereby achieve velocity matching between light and microwaves. Further, the first and second waveguides 2A, 2B are respectively disposed just below the pair of dashed-line parts 52 and 52 (distance between electrodes is small), so that it is possible to reduce the distance between the pair of ridge parts constituting the interaction part, whereby the VπL can be reduced. Furthermore, in the present embodiment, the width W₂ of the dashed-line part 52 is larger than the ridge width Wr, so that it is possible to effectively apply an electric field to the ridge part 21, whereby the VπL can be reduced.

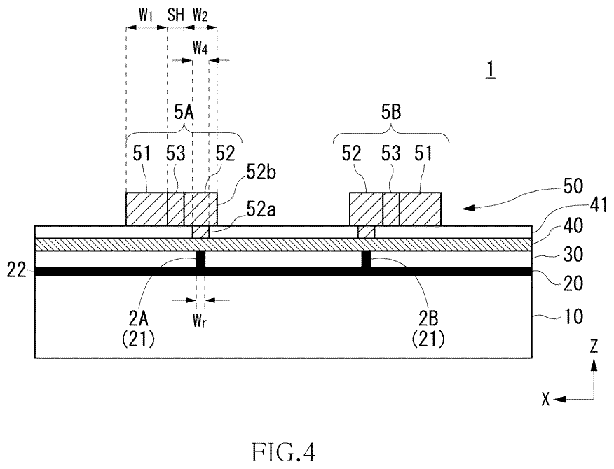

FIG. 4 is a schematic cross-sectional view illustrating the structure of an optical modulation element according to a second embodiment of the present disclosure.

As illustrated in FIG. 4, this optical modulation element 1 is featured in that the dashed-line part 52 of each of the first and second signal electrodes 5A, 5B has a two-layer structure and that a width W₄ of a lower layer 52a is smaller than a width W₂ of an upper layer 52b. Other configurations are the same as those of the first embodiment.

The lower layer 52a of the dashed-line part 52 can be obtained by forming a dielectric layer 41 on the upper surface of the buffer layer 40, then forming a trench pattern penetrating the dielectric layer 41, and finally filling the trench pattern with an electrode material. Thereafter, the electrode layer 50 including the upper layer 52b is formed, whereby the dashed-line part 52 having a downwardly protruding shape in a sectional view is completed.

According to the present embodiment, an electric field generated from the dashed-line parts 52 can be concentrated on the ridge part 21, which can lead to improvement in electric field efficiency and to a further reduction in the VπL.

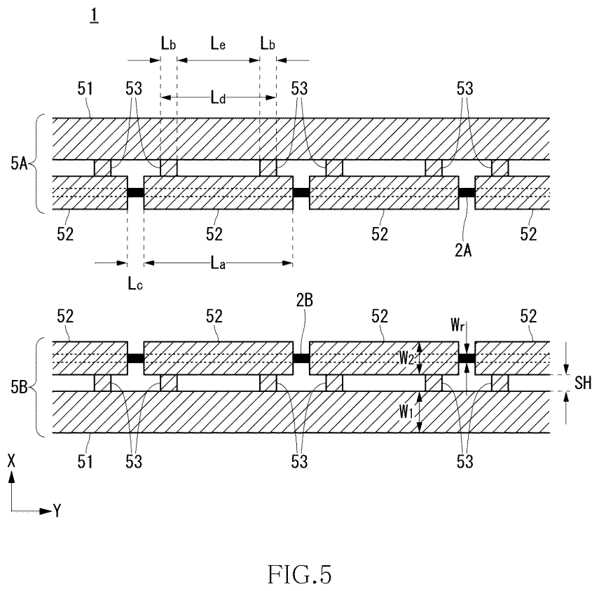

FIG. 5 is a schematic plan view illustrating the structure of an optical modulation element according to a third embodiment of the present disclosure.

As illustrated in FIG. 5, this optical modulation element 1 is featured in that one dashed-line part 52 is connected to the solid-line part 51 through a plurality of (two, in the present embodiment) connection parts 53. Thus, the Y-direction length Lb of one connection part 53 in the present embodiment is smaller than the Y-direction length Lb of the connection part 53 in the first embodiment. That is, the solid-line part 51 and one dashed-line part 52 are parallelly connected not using one connection part 53 having a larger Y-direction length but using a plurality of connection parts 53 each having a smaller Y-direction length. Other configurations are the same as those of the first embodiment.

As in the case with the length Lb of one connection part 53 in the first embodiment, the maximum distance Ld of the formation area of the plurality of connection parts 53 connected to one dashed-line part 52 is larger than half of the length La of the dashed-line part 52 (Lb/La>0.5). When the maximum distance Ld of the formation area of the connection part 53 is excessively small, the Nm excessively increases to make it difficult to achieve velocity matching between light and microwaves. By making the maximum length Ld of the formation area of the plurality of connection parts 53 connected to one dashed-line part 52 larger than half of the length La of the dashed-line part 52, even when a high dielectric constant substrate is used for the substrate, it is possible to prevent an excessive increase in the Nm without making the thickness of the electrode layer excessively large to allow achievement of velocity matching between light and microwaves. Regarding a change in the speed of microwaves, the length between the branching point from the solid-line part 51 to the dashed-line part 52 and multiplexing point from the dashed-line part 52 to the solid-line part 51 is important. Thus, in the present embodiment, the values of the length Lb of the connection part 53 and a distance Le between the plurality of connection parts 53 when the maximum distance Ld of the formation area of the connection parts 53 is made constant have a little influence on the Nm.

As described above, according to the present embodiment, the solid-line part 51 and dashed-line part 52 are parallelly connected to each other through the plurality of connection parts 53, and the interval between the plurality of connection parts 53 connected to one dashed-line part 52 is increased, so that a range having an insulator between the solid-line part 51 and the dashed-line part 52 increases to thereby reduce the VπL, thus making it possible to reduce the drive voltage of the optical modulation element.

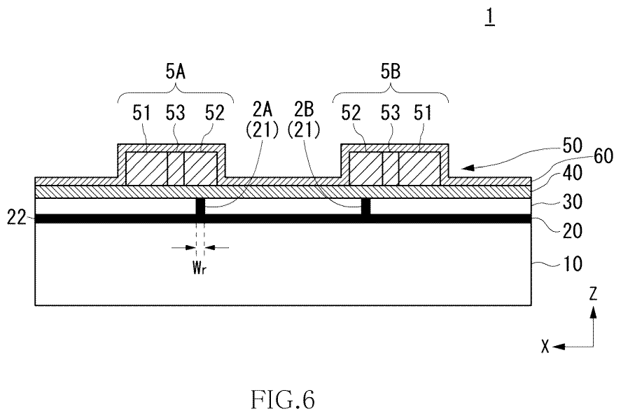

FIG. 6 is a schematic cross-sectional view illustrating the structure of an optical modulation element according to a fourth embodiment of the present disclosure.

As illustrated in FIG. 6, this optical modulation element 1 is featured in that the electrode layer 50 is covered with a dielectric layer 60. As described above, the electrode layer 50 has the solid-line part 51, dashed-line part 52, and connection part 53, and the dielectric layer 60 covers the exposed surface of these electrode parts. The dielectric layer 60 covers not only the exposed surface of the electrode pattern but also the entire exposed surface of a part of the underlying layer (buffer layer 40) that is not covered with the electrode pattern. The material of the dielectric layer 60 may be Al₂O₃, SiN, resin, or a combination of these materials. In particular, when SiN or resin is used, stress can be reduced by reducing the film thickness, whereby reliability can be increased. The exposed surface refers to surfaces of the electrode layer 50 that are not covered with the underlying layer (buffer layer 40).

The upper surfaces of the solid-line part 51, dashed-line part 52, and connection part 53 are preferably the same in height. This can enhance the coverage of the dielectric layer 60, which in turn can enhance an effect of increasing the effective refractive index Nm of microwaves. The “same (in height)” includes errors due to manufacturing variations or surface roughness.

As described above, according to the present embodiment, by covering the electrode layer 50 with the dielectric layer 60, the effective refractive index Nm of microwaves can be increased.

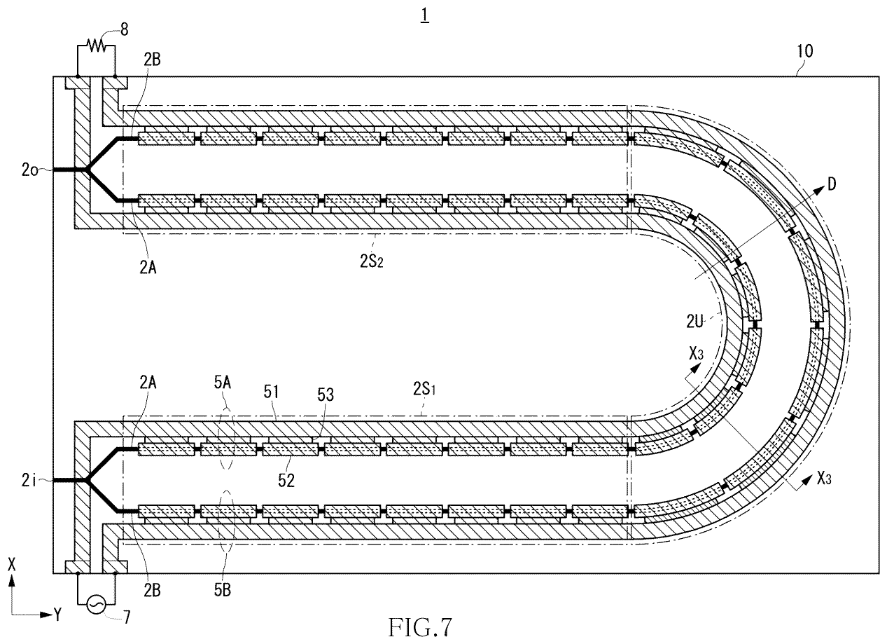

FIG. 7 is a schematic plan view illustrating the structure of an optical modulation element according to a fifth embodiment of the present disclosure.

As illustrated in FIG. 7, this optical modulation element 1 is featured in that the Mach-Zehnder optical waveguide 2 has a folded structure. More specifically, the first and second waveguides 2A, 2B of the Mach-Zehnder optical waveguide 2 have a first straight section 2S₁, a curved section 2U that turns the traveling direction of the first straight section 2S₁ by 180°, and a second straight section 2S₂ extending parallel to the first straight section 2S₁.

The optical input port 2i and optical output port 2o are both provided at one end side of the substrate 10 in the longitudinal direction (Y-direction). The first and second waveguides 2A, 2B of the first straight section 2S₁ travel in parallel to each other from the one end side of the substrate 10 in the longitudinal direction to the other end side thereof. The first and second waveguides 2A, 2B of the curved section 2U are formed into concentric semicircles for turning the traveling direction of the first straight section 2S₁. The first and second waveguides 2A, 2B of the second straight section 2S₂ travel in parallel to each other from the other end side of the substrate 10 in the longitudinal direction to the one end side thereof.

The first and second signal electrodes 5A, 5B are each continuously formed along the first straight section 2S₁, curved section 2U, and second straight section 2S₂ of the Mach-Zehnder optical waveguide 2. Forming the pair of signal electrodes as long as possible along not only the straight section of the optical waveguide but also the curved section can increase the interaction length, allowing a reduction in drive voltage. Optical modulation elements have a practical problem that the long side of the main body has a large length; however, adopting such a folded structure can significantly reduce the length of the long side, allowing achievement of both lower drive voltage and miniaturization. In particular, an optical waveguide formed using a lithium niobate film has a reduced loss even when the curvature radius of the curved section 2U is reduced to about 50 μm and is thus suitably applied to the present embodiment.

As described above, the Mach-Zehnder optical waveguide 2 has the first straight section 2S₁, curved section 2U, and second straight section 2S₂, and the first and second signal electrodes 5A, 5B constituting the differential line are formed along not only the first and second straight sections 2S₁, 2S₂ but also the curved section 2U. That is, the solid-line part 51, dashed-line part 52, and connection part 53 constituting the first and second signal electrodes 5A, 5B are formed along not only the first and second straight sections 2S₁, 2S₂ but also the curved section 2U.

In the curved section 2U, the width direction of the connection part 53 preferably coincides with the normal direction (denoted by the arrow D) of the solid-line part 51. By making not only the dashed-line part 52 but also the connection part 53 conform to the curved shape of the curved section 2U, the value of the effective refractive index Nm of microwaves is not changed even in the curved section 2U, allowing achievement of velocity matching between light and microwaves.

According to the present embodiment, in addition to the effects obtained in the first embodiment, an electric field can be applied not only to the straight section of the optical waveguide but also to the curved section thereof to thereby increase the interaction length between light and microwaves, allowing achievement of a lower drive voltage.

While the preferred embodiments of the present disclosure have been described, the present disclosure is not limited to the above embodiments, and various modifications may be made within the scope of the present disclosure, and all such modifications are included in the present disclosure.

The technology according to the present disclosure includes the following configuration examples, but not limited thereto.

An optical modulation element according to one embodiment of the present disclosure includes; a substrate; a waveguide formed of an optical material film having a ridge part which are disposed on the substrate and including first and second waveguides provided parallel to each other; a buffer layer disposed on the first and second waveguides; and first and second signal electrodes provided along the first and second waveguides. The first and second signal electrodes each include a solid-line part provided outside the respective first and second waveguides in a plan view and provided continuously in the traveling direction, a dashed-line part provided at positions inside the solid-line parts so as to overlap the respective first and second waveguides in a plan view and provided intermittently in the traveling direction, and a connection part connecting the solid-line part and the dashed-line part. A width of the dashed-line part is larger than a width of the ridge part. By thus adding the dashed-line part and connection part to the signal electrode, it is possible to increase the effective refractive index Nm of microwaves to reduce the phase speed thereof, thus allowing achievement of velocity matching between light and microwaves. Further, the dashed-line parts are provided just above the ridge parts constituting the first and second waveguides, that is, the ridge parts are disposed not just below the solid-line parts, but just below the dashed-line parts, so that it is possible to reduce the distance between the pair of ridge parts to thereby allow a reduction in the VπL. The width of the dashed-line part is larger than that of the ridge part, and hence, an electric field can be efficiently applied to the ridge part, which makes it possible to obtain a greater reduction effect of the VπL.

The dashed-line part may have an upper layer and a lower layer, and a width of the lower layer may be larger than the width of the ridge part and smaller than a width of the upper layer. The dashed-line part just below the ridge part has a downwardly protruding shape, so that an electric field from the signal electrode can be concentrated on the ridge part, making it possible to enhance a reduction effect of the VπL.

The optical modulation element according to the embodiment of the present disclosure may further include a first dielectric layer provided on the buffer layer. The upper layer of the dashed-line part may be provided on the first dielectric layer, and the lower layer of the dashed-line part may be filled in a trench pattern formed in the first dielectric layer. With this configuration, an electric field generated from the dashed-line part can be concentrated on the ridge part, which can lead to improvement in electric field efficiency and to a further reduction in the VπL.

A width of the solid-line part may be larger than the width of the dashed-line part. This allows propagation of microwaves to concentrate on the solid-line part to thereby suppress an excessive increase in the effective refractive index Nm of microwaves.

A maximum distance between both ends of the connection part in the traveling direction may be equal to or larger than half of a length of a line segment pattern constituting the dashed-line part. By increasing the interval of the connection parts each connected to one line segment pattern constituting the dashed-line part, an excessive increase in the Nm is suppressed. Suppressing the excessive increase in the Nm prevents an increase in the height of the electrode to make the electrode hardly fall.

Each of the line segment patterns constituting the dashed-line part may be parallelly connected to the solid-line part through a plurality of the connection parts. By constituting the connection part by a plurality of thin conductor patterns, a reduction effect of the VπL can be enhanced as compared with when the connection part is constituted by one thick conductor pattern.

The optical modulation element according to the embodiment may further include a second dielectric layer covering exposed surfaces of the first and second signal electrodes. By covering the first and second signal electrodes with the dielectric layer, the effective refractive index Nm of microwaves can be increased.

Upper surfaces of the respective solid-line part, dashed-line part, and connection part may be the same in height. When the electrode upper surfaces are flush with one another, the range covered with the dielectric layer is increased, making it possible to enhance an effect of increasing the Nm.

The dielectric layer may be made of resin or SiN. Using an organic resin or SiN having a high dielectric constant can reduce film thickness, thereby increasing reliability.

The first and second waveguides may have a straight section and a curved section, and the dashed-line parts of the respective first and second signal electrodes may respectively overlap the first and second waveguides both in the straight section and curved section in a plan view. Thus, an electric field is applied to the first and second waveguides even in the curved section, thus increasing the length of the interaction part to reduce a drive voltage.

In the curved section, the connection part may be substantially parallel to the normal direction of the solid-line part. Thus, the value of the effective refractive index Nm is not changed in the curved section, allowing achievement of velocity matching between light and microwaves.

### EXAMPLES

In the optical modulation element according to the present disclosure, the influence that the dimension of the signal electrode had on the effective refractive index Nm of microwaves was evaluated by simulations. The basic shape of the optical modulation element was designed such that, in the electrode structure illustrated in FIG. 5, the thickness T of the electrode layer=6 μm, width W₁ of the solid-line part=10 μm, width W₂ of the dashed-line part=6 μm, width SH of the connection part=8 μm, ratio Ld/La (%) of the maximum distance (connection part area length Ld) of the formation area of the plurality of connection parts connected to the line segment pattern of the dashed-line part to the length (dashed-line part length La) of the line segment pattern=50%, and effective refractive index No (Nm target value) of light=2.26.

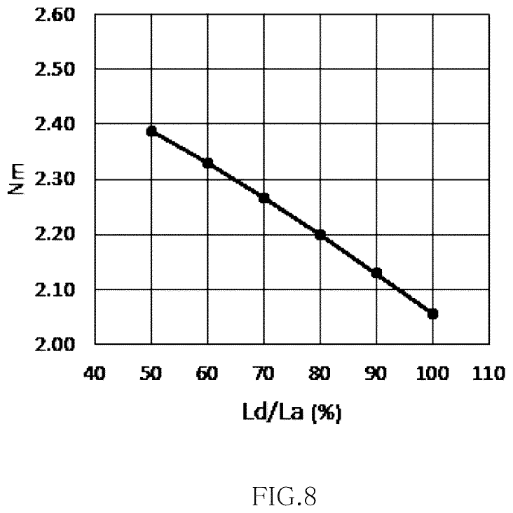

FIG. 8 is a graph illustrating a change in the Nm when the connection part area length Ld is changed. The horizontal axis represents the ratio Ld/La (%) of the connection part area length to dashed-line part length, and the vertical axis represents the Nm.

The graph of FIG. 8 reveals that the larger the connection part area length Ld relatively, the smaller the Nm. To achieve Nm=2.26 in the present example, Ld/La needs to be approximately equal to 73%. To increase the Nm, it is desirable to reduce the connection part area length Ld; however, when the connection part area length Ld is excessively small, the Nm becomes as excessively large as about 2.4. Thus, the ratio (%) of the connection part area length to dashed-line part length is preferably 50% or more.

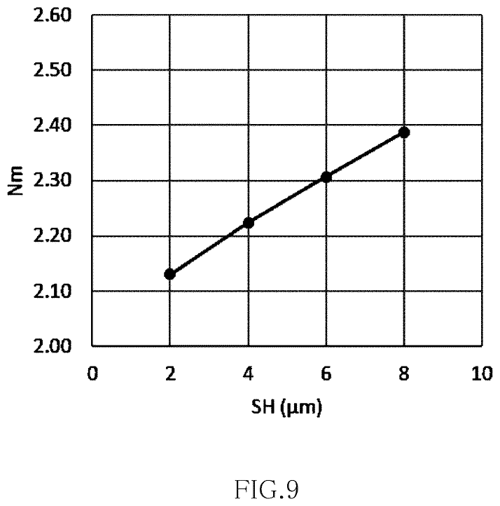

FIG. 9 is a graph illustrating a change in the Nm when the width SH of the connection part is changed. The horizontal axis represents the width SH (μm) of the connection part, and the vertical axis represents the Nm.

The graph of FIG. 9 reveals that the larger the width SH of the connection part is, the larger the Nm becomes. To achieve Nm=2.26 in the present example, SH needs to be approximately equal to 5 μm.

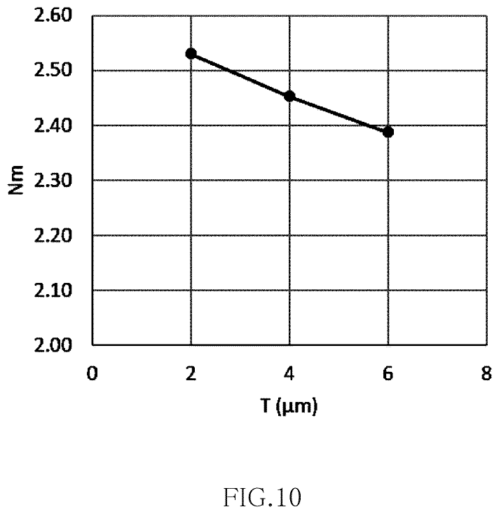

FIG. 10 is a graph illustrating a change in the Nm when the thickness T of the electrode layer is changed. The horizontal axis represents the thickness T (μm) of the electrode layer, and the vertical axis represents the Nm.

The graph of FIG. 10 reveals that the larger the thickness T of the electrode layer is, the smaller the Nm becomes. To increase the Nm, it is preferable to reduce the thickness T of the electrode layer. Since Nm=2.53 when T=2 μm, and Nm=2.39 when T=6 μm, the thickness T of the electrode layer needs to be further increased in order to achieve Nm=2.26. However, it is difficult to make the thickness of the electrode layer large due to restrictions on the manufacturing process. Further, when the thickness of the electrode is made excessively large, the electrode may fall. Thus, it is desirable to adjust the Nm not by increasing the thickness T of the electrode layer but by adjusting another parameter such as the connection area length.

### REFERENCE SIGNS LIST

1: Optical modulation element
2: Mach-Zehnder optical waveguide
2A: First waveguide
2B: Second waveguide
2C: Input waveguide
2D: Demultiplexer
2E: Multiplexer
2F: Output waveguide
2S₁: First straight section
2S₂: Second straight section
2U: Curved section
2i: Optical input port
2o: Optical output port
5A: First signal electrode
5B: Second signal electrode
7: Driver circuit
8: Terminal resistor
10: Substrate
20: Waveguide layer
21: Ridge part
22: Slab part
30: Protective layer
40: Buffer layer
41: Dielectric layer
50: Electrode layer
51: Solid-line part
52: Dashed-line part
52a: Lower layer of dashed-line part
52b: Upper layer of dashed-line part
53: Connection part
56a, 57a: Draw-out part of first signal electrode
56b, 57b: Draw-out part of second signal electrode
58a, 59a: Terminal part of first signal electrode
58b, 59b: Terminal part of second signal electrode
60: Dielectric layer

1. An optical modulation element comprising:
a substrate;
first and second waveguides formed of an optical material film having a ridge part which are disposed on the substrate and provided parallel to each other;
a buffer layer disposed on the first and second waveguides; and
first and second signal electrodes provided along the first and second waveguides, wherein
the first and second signal electrodes each include
a solid-line part provided outside the respective first and second waveguides in a plan view and provided continuously in the traveling direction,
a dashed-line part provided at positions inside the solid-line parts so as to overlap the respective first and second waveguides in a plan view and provided intermittently in the traveling direction, and
a connection part connecting the solid-line part and the dashed-line part, and
a width of the dashed-line part is larger than a width of the ridge part.

2. The optical modulation element according to claim 1, wherein the dashed-line part has an upper layer and a lower layer, and a width of the lower layer is larger than the width of the ridge part and smaller than a width of the upper layer.

3. The optical modulation element according to claim 2 further comprising a first dielectric layer provided on the buffer layer, wherein the upper layer of the dashed-line part is provided on the first dielectric layer, and the lower layer of the dashed-line part is filled in a trench pattern formed in the first dielectric layer.

4. The optical modulation element according to claim 1, wherein a width of the solid-line part is larger than the width of the dashed-line part.

5. The optical modulation element according to claim 1, wherein a maximum distance between both ends of the connection part in the traveling direction is equal to or larger than half of a length of a line segment pattern constituting the dashed-line part.

6. The optical modulation element according to claim 1, wherein each of the line segment patterns constituting the dashed-line part is parallelly connected to the solid-line part through a plurality of the connection parts.

7. The optical modulation element according to claim 1 further comprising a second dielectric layer covering exposed surfaces of the first and second signal electrodes.

8. The optical modulation element according to claim 7, wherein upper surfaces of the respective solid-line part, dashed-line part, and connection part are the same in height.

9. The optical modulation element according to claim 7, wherein the dielectric layer is made of resin or SiN.

10. The optical modulation element according to claim 1, wherein the first and second waveguides have a straight section and a curved section, and the dashed-line parts of the respective first and second signal electrodes respectively overlap the first and second waveguides both in the straight section and curved section in a plan view.
